(19) United States
(12) Patent Application Publication
(10) Pub. No.: US 2023/0305620 A1
(43) Pub. Date: Sep. 28, 2023

(54) INFORMATION PROCESSING APPARATUS, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventors: Dai TAKESHIMA, Kanagawa (JP); Koji UDAGAWA, Kanagawa (JP); Kazuhiko NARUSHIMA, Kanagawa (JP); Masayoshi MIKI, Kanagawa (JP); Takaki SAIKI, Kanagawa (JP); Masahito SHIKATA, Kanagawa (JP); Hidenori HORIE, Kanagawa (JP); Yuji MURATA, Kanagawa (JP)

(73) Assignee: FUJIFILM Business Innovation Corp., Tokyo (JP)

(21) Appl. No.: 17/895,035

(22) Filed: Aug. 24, 2022

(30) Foreign Application Priority Data
Mar. 25, 2022 (JP) 2022-049602

(51) Int. Cl. G06F 1/3296

(52) U.S. Cl. CPC G06F 1/3296

(57) ABSTRACT

An information processing apparatus includes a processor configured to output a set value of a transition time until an apparatus transitions to a power saving state, which is obtained based on a first history of a time interval of each processing executed by the apparatus and a target value of a return time required until the apparatus returns from the power saving state.

### CROSS-REFERENCE TO RELATED APPLICATIONS

This application is based on and claims priority under 35 USC 119 from Japanese Patent Application No. 2022-049602 filed Mar. 25, 2022.

### BACKGROUND

### (i) Technical Field

The present disclosure relates to an information processing apparatus, a non-transitory computer readable medium storing a program, and an information processing method.

### (ii) Related Art

An apparatus having a power saving function has been known.

JP2014-502929A describes a system that supplies a timeout value for an apparatus such as a printer.

### SUMMARY

Incidentally, the amount of processing executed by the apparatus and an interval of each processing may be different for each period such as a day or a week. Thus, in a case where a time until the apparatus transitions to a power saving state is constant, convenience of a user who uses the apparatus may deteriorate.

Aspects of non-limiting embodiments of the present disclosure relate to an information processing apparatus, a non-transitory computer readable medium storing a program, and an information processing method that suppress deterioration in convenience of a user who uses an apparatus as compared with a case where a time until the apparatus transitions to a power saving state is constant.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to output a set value of a transition time until an apparatus transitions to a power saving state, which is obtained based on a first history of a time interval of each processing executed by the apparatus and a target value of a return time required until the apparatus returns from the power saving state.

### BRIEF DESCRIPTION OF THE DRAWINGS

Exemplary embodiment(s) of the present invention will be described in detail based on the following figures, wherein:

FIG. 1 is a block diagram showing a hardware configuration of an image forming apparatus according to an exemplary embodiment;

FIG. 2 is a diagram showing each mode of the image forming apparatus;

FIG. 3 is a block diagram showing a function of calculating a set value of a transition time;

FIG. 4 is a diagram showing a job history;

FIG. 5 is a diagram showing the job history;

FIG. 6 is a diagram showing a calculation result of an average value of UI return times;

FIG. 7 is a diagram showing a relationship between an SP transition time and the average value of the UI return times;

FIG. 8 is a diagram showing a relationship between the SP transition time and a ratio of 1 second or less;

FIG. 9 is a diagram showing the relationship between the SP transition time and the ratio of 1 second or less;

FIG. 10 is a diagram showing the relationship between the SP transition time and the ratio of 1 second or less; and

FIG. 11 is a diagram showing the relationship between the SP transition time and the ratio of 1 second or less.

### DETAILED DESCRIPTION

In an exemplary embodiment, a set value of a time until a state of a processing apparatus transitions to a power saving state is calculated based on a processing history by an apparatus that executes processing (hereinafter, referred to as a “processing apparatus”). Hereinafter, the time until the state of the processing apparatus transitions to the power saving state is referred to as a “transition time”.

The processing apparatus may be any apparatus as long as the apparatus has a function of transitioning to a non-power saving state to a power saving state. The non-power saving state is a state where power is supplied to each part constituting the processing apparatus and each part is operating, and is a state where the processing apparatus can execute the processing. The power saving state is a state where power is not supplied to some parts constituting the processing apparatus or a state where power lower than power in the non-power saving state is supplied to some or all the parts constituting the processing apparatus.

For example, in a case where the state of the processing apparatus is the non-power saving state and a transition time elapses from a point in time at which the processing apparatus performs processing last or a point in time at which the processing apparatus is operated last by a user, the state of the processing apparatus transitions to the power saving state.

In a case where the state of the processing apparatus is the power saving state and a specific event occurs, the processing apparatus returns from the power saving state to the non-power saving state. The non-power saving state is returned, and thus, the processing apparatus can execute the processing. The specific event is an event corresponding to an instruction about returning. For example, in a case where a return button is provided in the processing apparatus and the user presses the return button, the processing apparatus returns from the power saving state to the non-power saving state. In a case where the processing apparatus receives an instruction to execute the processing, the processing apparatus may return from the power saving state to the non-power saving state.

A time (hereinafter, referred to as a “return time”) is required for the processing apparatus to return from the power saving state to the non-power saving state. The return time is a time required for a state of each part constituting the processing apparatus to change from the power saving state to a state where processing and functions can be executed. Since the function, performance, characteristics, or the like are different for each part constituting the processing apparatus, the return time may be different for each part.

In the exemplary embodiment, the set value of the transition time until the processing apparatus transitions to the power saving state based on a first history of a time interval of each processing executed by the processing apparatus and a target value of the return time of the processing apparatus is calculated. For example, it is considered that the calculated set value is set in the processing apparatus and the processing apparatus transitions to the power saving state according to the set value. The set value may be set in the processing apparatus according to an instruction of the user, or may be automatically set in the processing apparatus.

In the following description, the exemplary embodiment will be described by taking an image forming apparatus as an example of the processing apparatus, but the image forming apparatus is merely an example of the processing apparatus, and the exemplary embodiment may be applied to an apparatus other than the image forming apparatus.

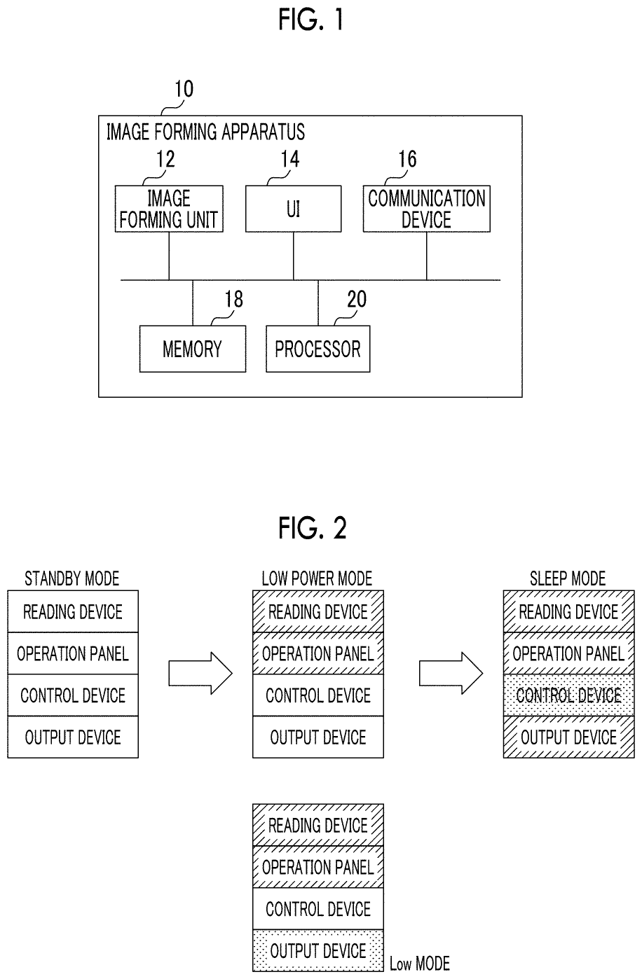

A hardware configuration of an image forming apparatus 10 according to the exemplary embodiment will be described with reference to FIG. 1. FIG. 1 is a block diagram showing the hardware configuration of the image forming apparatus 10.

The image forming apparatus 10 includes an image forming unit 12, a UI 14, a communication device 16, a memory 18, and a processor 20. The image forming apparatus 10 is a printer, a scanner, a copier, a facsimile, or a multifunction apparatus (for example, an apparatus having functions of a plurality of apparatuses such as a printer, a scanner, and a copier).

The image forming unit 12 has at least one function of a print function, a scan function, a copy function, or a facsimile function. A printing method, scanning method, and the like are not particularly limited. For example, as a printing method, an electrophotographic method, an inkjet method, a thermosensitive method, a thermal transfer method, or the like is used.

The UI 14 is a user interface and includes a display and an input device. The display is a liquid crystal display, an EL display, or the like. The input device is a keyboard, a mouse, an input key, an operation panel, or the like. The UI 14 may be a UI such as a touch panel having both a display and an input device.

The communication device 16 includes one or a plurality of communication interfaces having a communication chip, a communication circuit, and the like, and has a function of transmitting information to another apparatus and a function of receiving information from the other apparatus. The communication device 16 may have a wireless communication function such as short-range wireless communication or Wi-Fi (registered trademark), or may have a wired communication function.

The memory 18 is a device constituting one or a plurality of storage regions for storing data. The memory 18 is, for example, a hard disk drive (HDD), a solid state drive (SSD), various memories (for example, RAM, DRAM, NVRAM, ROM, and the like), other storage devices (for example, an optical disk or the like), or a combination thereof.

The processor 20 controls an operation of each part of the image forming apparatus 10.

The processor 20 calculates a set value of a transition time until the image forming apparatus 10 transitions to a power saving state based on a first history of a time interval of each processing executed by the image forming apparatus 10 and a target value of a return time required for the image forming apparatus 10 to return from the power saving state to the non-power saving state. For example, the first history is acquired for each predetermined period, and the processor 20 calculates a set value of a transition time in a future period. In a case where a predetermined period is one day, the first history for each day is acquired, and the processor 20 calculates a set value of a transition time for a future day (for example, a next day).

Here, a specific example of a power state of the image forming apparatus 10 will be described. The power state of the image forming apparatus 10 includes a standby state and a power saving state. The standby state is an example of a non-power saving state. In the following description, a mode of the image forming apparatus 10 in a case where the power state of the image forming apparatus 10 is the standby state is referred to as a “standby mode”, and the mode of the image forming apparatus 10 in a case where the power state of the image forming apparatus 10 is the power saving state is referred to as a “power saving mode”.

The standby mode is a state where the image forming apparatus 10 is on standby. Specifically, in the standby mode, power is supplied to each part constituting the image forming apparatus 10 and each part is operating. The state of the image forming apparatus 10 at this time is a state where the image forming apparatus 10 can accept processing (for example, a print job, a scan instruction, a copy instruction, or the like) and execute the processing.

The power saving mode is a state where power is not supplied to some parts of the image forming apparatus 10 or a state where power lower than power in the standby mode is supplied to some or all the parts of the image forming apparatus 10.

For example, in a case where the mode of the image forming apparatus 10 is the standby mode and a user operates the UI 14 to give an instruction about the power saving mode (for example, in a case where a power saving button is pressed), the processor 20 changes the mode of the image forming apparatus 10 from the standby mode to the power saving mode.

As another example, a time during which the mode transitions from the standby mode to the power saving mode (that is, a “transition time”) may be set. A set value of the transition time is stored in the memory 18. In a case where the mode of the image forming apparatus 10 is the standby mode and a time during which the image forming apparatus 10 does not perform processing such as a print job or a time during which the UI 14 is not operated by the user is equal to or greater than the transition time, the processor 20 changes the mode of the image forming apparatus 10 from the standby mode to the power saving mode. That is, in a case where the transition time elapses from the point in time at which the apparatus executes processing last or the point in time at which the apparatus is operated last, the processor 20 changes the mode of the image forming apparatus 10 from the standby mode to the power saving mode.

In a case where the mode of the image forming apparatus 10 is the power saving mode and a specific event occurs, the processor 60 returns each part of the image forming apparatus 10 from the power saving mode to the standby mode. A state where the mode returns to the standby mode is a state where each part constituting the image forming apparatus 10 can execute processing or a function such as a print job. The state where the mode returns to the standby mode means that the state of each part constituting the image forming apparatus 10 transitions from the state in the power saving mode to the state where processing and functions can be executed. The specific event is an event corresponding to the instruction about returning. For example, in a case where the return button is provided on the operation panel and the user presses the return button, the processor 20 determines that the specific event occurs and changes the mode of the image forming apparatus 10 from the power saving mode to the standby mode. In a case where the part constituting the image forming apparatus 10 is powered off in the power saving mode, the part is powered on by the processor 20. In a case where the power supplied to the part is lower than the power in the standby mode, the processor 20 supplies the power in the standby mode to the part. In a case where the print job is transmitted from an external apparatus to the image forming apparatus 10 and the processor 20 accepts the print job, the processor 20 determines that the specific event occurs and changes the mode of the image forming apparatus 10 from the power saving mode to the standby mode. The specific event described herein is merely an example of the event that causes the return, and other events may be set as the event that causes the return.

A plurality of different modes are set as the power saving mode, and the processor 20 may stepwisely change the power saving mode of the image forming apparatus 10. For example, a first power saving mode and a second power saving mode are set. The second power saving mode is a mode in which power consumption is less than in the first power saving mode.

For example, the first power saving mode and the second power saving mode are set in consideration of an energy saving effect and the return time. The return time is a time required for each part of the image forming apparatus 10 to return from the power saving mode to the standby mode. That is, the return time is a time required for the state of each part constituting the image forming apparatus 10 to change from the state in the power saving mode to the state where processing and functions can be executed. The return time may be different for each part constituting the image forming apparatus 10. For example, a return time of a part, such as an operation panel that functions immediately in a case where power is supplied is relatively short. On the other hand, a return time of a part such as a fixing device that functions after a certain amount of time elapses since the supply of the power is stated is relatively long. In a case where the fixing device is described as an example, since it is necessary to raise a temperature of the fixing device to a target temperature required for fixing, the transition time becomes long by time required for the temperature rise. In general, in a case where the fixing device is powered off once, it takes a long time until actual printing can be performed from the state where the fixing device is powered off.

The return time corresponds to a time while the user is waiting for the state of the image forming apparatus 10 to transition from the power saving mode to the standby mode. Thus, the return time can be expressed as a standby time for the user.

In a case where a plurality of different modes are set as the power saving mode, the transition time is set for each power saving mode. For example, a first transition time which is a transition time from the standby mode to the first power saving mode and a second transition time which is a transition from the first power saving mode to the second power saving mode are set.

In a case where the mode of the image forming apparatus 10 is the standby mode and a time during which the processing is not performed by the image forming apparatus 10 or a time during which the UI 14 is not operated by the user is equal to or greater than the first transition time, the processor 20 changes the mode of the image forming apparatus 10 from the standby mode to the first power saving mode. That is, in a case where the first transition time elapses from the point in time at which the apparatus performs processing last or is operated last, the processor 20 changes the mode of the image forming apparatus 10 from the standby mode to the first power saving mode. In a case where the mode of the image forming apparatus 10 is the first power saving mode and the specific event causing the return occurs, the processor 20 changes the mode of the image forming apparatus 10 from the first power saving mode to the standby mode.

In a case where the mode of the image forming apparatus 10 is the first power saving mode and the time during which the image forming apparatus 10 does not perform processing or the time during which the UI 14 is not operated by the user is equal to or greater than the second transition time, the processor 20 changes the mode of the image forming apparatus 10 from the first power saving mode to the second power saving mode. That is, in a case where the second transition time elapses without any processing or operation from a point in time at which the mode transitions to the first power saving mode, the processor 20 changes the mode of the image forming apparatus 10 from the first power saving mode to the second power saving mode. In a case where the mode of the image forming apparatus 10 is the second power saving mode and the specific event causing the return occurs, the processor 20 changes the mode of the image forming apparatus 10 from the second power saving mode to the standby mode.

The first power saving mode and the second power saving mode are merely examples, and three or more different power saving modes may be set and the power saving modes may be stepwisely changed.

Hereinafter, a specific example of each mode of the image forming apparatus 10 will be described with reference to FIG. 2. FIG. 2 shows an example of each mode.

For example, the mode of the image forming apparatus 10 includes the standby mode, the low power mode, and the sleep mode. In the following description, the low power mode may be referred to as an “LP mode” and the sleep mode may be referred to as an “SP mode”. As described above, the standby mode is a mode in which power is supplied to each part of the image forming apparatus 10. The low power mode and the sleep mode are examples of the power saving mode. The low power mode is an example of the first power saving mode, and the sleep mode is an example of the second power saving mode. The sleep mode is a mode in which power consumption is less than in the low power mode.

In the following description, each mode will be described as an example, focusing on the supply of power to each of a reading device, an operation panel, a control device, and an output device.

The reading device is a device included in the image forming unit 12, and is a device that generates image data by optically reading information on a document. The operation panel is a device included in the UI 14, and displays an image or accepts an instruction or the like from the user. The control device includes the memory 18 and the processor 20 and controls the image forming apparatus 10. The output device is a device included in the image forming unit 12 and is a device that executes a print function. For example, the output device includes a device that forms a toner image by exposure and development, a transfer device for transferring the toner image to the paper, and a fixing device for fixing the toner image transferred to the paper to the paper.

In the standby mode, power is supplied to each part of the image forming apparatus 10, and each part is operating. Specifically, power is supplied to the reading device, the operation panel, the control device, and the output device, and these devices are operating.

In the low power mode, the reading device and the operation panel are in the power saving state. Specifically, the reading device and the operation panel are powered off, and power is not supplied to the reading device and the operation panel. For example, in a case where the operation panel has a backlight, that backlight is turned off.

A Low mode as the low power mode may be executed. The Low mode is a mode in which power for maintaining a temperature of the fixing device within a predetermined temperature range is supplied to the output device without powering off the output device. The predetermined temperature range is a temperature range lower than the temperature of the fixing device during printing (that is, a target temperature required for fixing), and is a range of a temperature higher than the temperature of the fixing device before the fixing device is heated in a state where the fixing device is powered off. The predetermined temperature range may be a constant temperature. The temperature of the fixing device is lowered to a temperature lower than the target temperature required for fixing, and thus, the power consumption of the fixing device is reduced. The return time to the standby mode is shorter than in a case where the fixing device is powered off. As described above, in the Low mode, both the reduction in the power consumption of the fixing device and the reduction in the return time of the fixing device are realized.

In the sleep mode, the reading device, the operation panel, and the output device are in a power saving state. Specifically, the reading device, the operation panel, and the output device are powered off, and power is not supplied to the reading device, the operation panel, and the output device.

In the sleep mode, the control device is in the power saving state. For example, a state where a clock of the processor 20 included in the control device is turned off, a state where the supply of power to the processor 20 is stopped, or a state where the supply of power to parts other than the memory 18 included in the control device is stopped is an example of the power saving state of the control device. These states are merely examples of the sleep mode, and in a case where the power consumption in the sleep mode is lower than the power consumption in the low power mode, another power control may be performed.

The transition time is set for each power saving mode. For example, the first transition time which is the time during which the mode transitions from the standby mode to the low power mode, and the second transition time which is the time during which the mode transitions from the low power mode to the sleep mode are set. A value of the first transition time and a value of the second transition time are stored in the memory 18.

In a case where the mode of the image forming apparatus 10 is the standby mode and the time during which the processing is not performed by the image forming apparatus 10 or the time during which the UI 14 is not operated by the user is equal to or greater than the first transition time, the processor 20 changes the mode of the image forming apparatus 10 from the standby mode to the low power mode. That is, in a case where the first transition time elapses since the point in time at which the apparatus performs processing last or is operated last, the processor 20 changes the mode of the image forming apparatus 10 from the standby mode to the low power mode.

In a case where the mode of the image forming apparatus 10 is the low power mode and the specific event causing the return occurs, the processor 20 changes the mode of the image forming apparatus 10 from the low power mode to the standby mode.

In a case where the mode of the image forming apparatus 10 is the low power mode and the time during which the processing is not performed by the image forming apparatus 10 or the time during which the UI 14 is not operated by the user is equal to or greater than the second transition time, the processor 20 changes the mode of the image forming apparatus 10 from the low power mode to the sleep mode.

That is, in a case where the second transition time elapses without any processing or operation from a point in time at which the mode transitions to the first power saving mode, the processor 20 changes the mode of the image forming apparatus 10 from the low power mode to the sleep mode.

In a case where the mode of the image forming apparatus 10 is the sleep mode and the specific event causing the return occurs, the processor 60 changes the mode of the image forming apparatus 10 from the sleep mode to the standby mode.

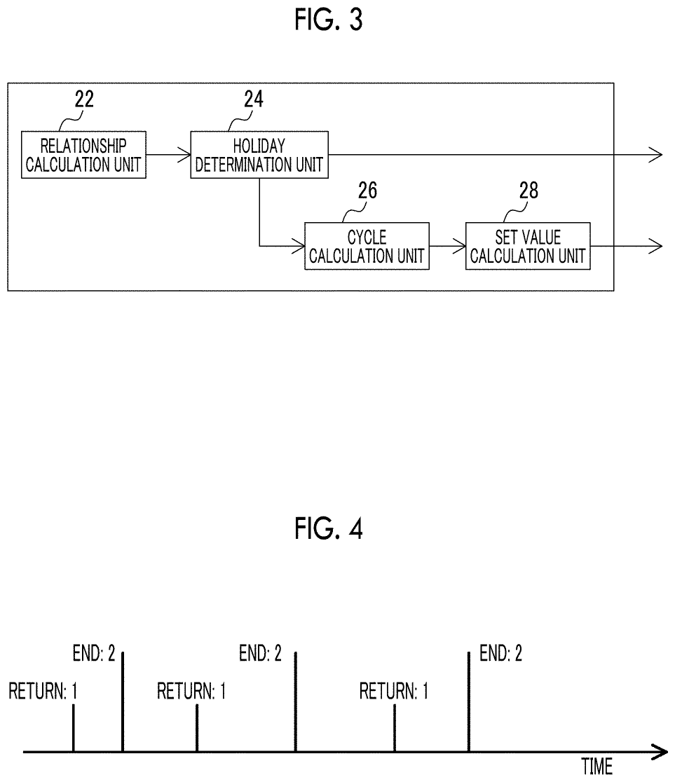

Hereinafter, a function of calculating the set value of the transition time will be described with reference to FIG. 3. FIG. 3 is a block diagram showing the function of calculating the set value of the transition time.

The image forming apparatus 10 includes a relationship calculation unit 22, a holiday determination unit 24, a cycle calculation unit 26, and a set value calculation unit 28. These functions are realized by the processor 20.

The relationship calculation unit 22 calculates a first relationship between the return time and the transition time based on the first history of the time interval of each processing executed by the image forming apparatus 10.

The return time mentioned herein is, for example, a UI return time. The UI return time is a time required to return the UI 14 from the power saving mode (for example, low power mode or sleep mode). The returning of the UI 14 means that a backlight of the operation panel included in the UI 14 is turned on and an operation using the operation panel can be performed. For example, in a case where the mode of the image forming apparatus 10 is the power saving mode (for example, low power mode or sleep mode), a specific event corresponding to the instruction about returning occurs. A time from a point in time at which the event occurs to a point in time at which the backlight of the operation panel included in the UI 14 is turned on and an operation using the operation panel can be performed is the UI return time.

The UI return time is different depending on the power saving mode. The UI return time from the low power mode is shorter than the UI return time from the sleep mode. For example, the UI return time from the low power mode is 0.7 seconds, and the UI return time from the sleep mode is 3.0 seconds. These values are merely examples. For the sake of convenience in calculation, the UI return time from the standby mode is set to 0.0 seconds.

The transition time mentioned herein is a time during which the mode transitions from the standby mode to the sleep mode (that is, the total of the first transition time and the second transition time). Hereinafter, the time during which the mode transitions from the standby mode to the sleep mode will be referred to as a “SP transition time”.

The first history of the time interval of each processing is a job history. The job mentioned herein is a set of a series of operations and processing performed from a return point in time to an end point in time. The return point in time is a point in time at which the image forming apparatus 10 returns from the power saving mode (for example, low power mode or sleep mode) to the standby mode. The end point in time is a point in time at which the execution of target processing is ended. For example, the returning to the standby mode, the operation by the user, the execution of the processing, and the end of the processing occur in this order, and a set including the returning, the operation, the execution of the processing, and the end of the processing is defined as one job.

The job history is a history of each job having occurred during a predetermined period. For example, times of the return point in time and the end point in time of each job are included in the job history. The predetermined period is, for example, one day, one week, one month, or the like, and may be set by the user.

The relationship calculation unit 22 virtually changes a value of the SP transition time, and calculates, as the first relationship, the UI return time for each SP transition time based on a relationship between a point in time at which processing included in each job is executed and the SP transition time. The point in time at which the processing is executed is, specifically, the return point in time and the end point in time.

The relationship calculation unit 22 receives the job history obtained for each predetermined period, and calculates the first relationship between the UI return time and the SP transition time for each job history in each period. For example, in a case where the period is one day, the relationship calculation unit 22 calculates the first relationship for each day based on the job history for each day.

The holiday determination unit 24 determines that a day on which the number of jobs is equal to or less than a threshold value is a holiday. A set value of a SP transition time for a next day of the day determined to be the holiday is not calculated by the set value calculation unit 28. In this case, a value determined by another method or a predetermined value is used as the set value of the SP transition time on the next day.

The cycle calculation unit 26 receives the first relationship of each period calculated by the relationship calculation unit 22, and specifies a period in which a relationship closest to a first relationship of a specific period (that is, the relationship between the UI return time and the SP transition time) is calculated. For example, in a case where the period is a day, the specific period is “today”. In this case, the cycle calculation unit 26 specifies a day on which a relationship closest to the first relationship on today is calculated. The specified day is determined to be a periodic day in the sense that the day is a day on which the same first relationship as today is obtained.

The set value calculation unit 28 specifies a next period of the period specified by the cycle calculation unit 26, and calculates the set value of the SP transition time based on the first relationship calculated based on the job history obtained in the next period (hereinafter, this first relationship is referred to as a “second relationship”) and the target value of the return time. The target value of the return time is set by the user. The target value may be set in advance.

For example, in a case where the period is “day”, the set value calculation unit 28 specifies a next day of the day specified by the cycle calculation unit 26, and calculates the set value of the SP transition time based on the first relationship on the next day (corresponding to the second relationship) and the target value of the return time is calculated.

The set value of the SP transition time is output. For example, the set value of the SP transition time may be displayed on the operation panel of the UI 14, or may be transmitted to a terminal device such as a personal computer (hereinafter, referred to as a “PC”), a tablet PC, or a smartphone, or may be set in the image forming apparatus 10.

Hereinafter, the exemplary embodiment will be described in detail with reference to specific examples.

FIG. 4 shows the job history. A horizontal axis indicates a time. Return 1 is a flag indicating a time at the return point in time. End 2 is a flag indicating a time at the end point in time. The processor 20 records, as a job history, the return point in time and the end point in time of each job. Data on the job history is stored in the memory 18.

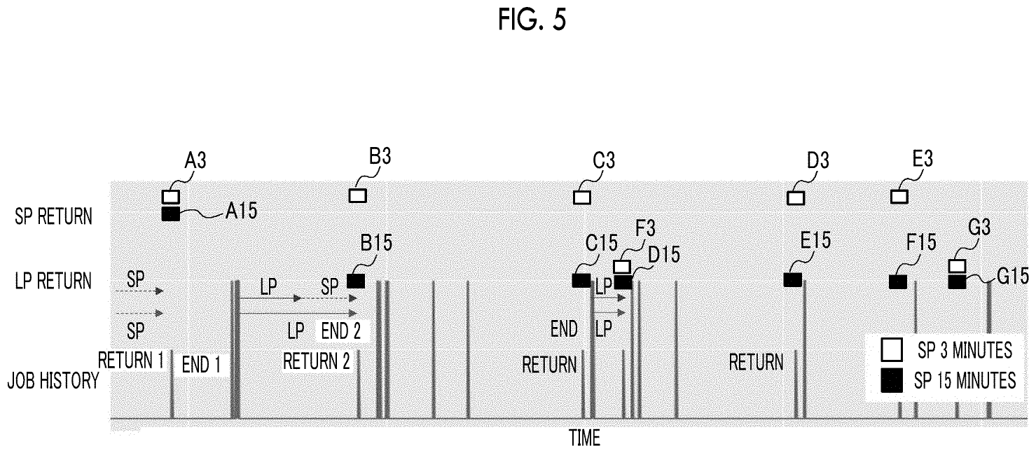

Hereinafter, the calculation of the first relationship between the UI return time and the SP transition time will be described with reference to FIG. 5. FIG. 5 shows the job history. The job history shown in FIG. 5 is a job history in a specific period. For example, the period is a day and the job history shown in FIG. 5 is a job history on “today”.

The processor 20 stores a history of a job executed by a predetermined time (for example, 20:00 or the like) for each day. The job history shown in FIG. 5 is the history of the job executed by the predetermined time on today. The processor 20 calculates the first relationship for each day when a predetermined time elapses.

An SP return in FIG. 5 indicates a return from the sleep mode. An LP return in FIG. 5 indicates a return from the low power mode.

A3 to G3 represented in white indicate return timings in a case where the SP transition time is assumed to be 3 minutes. A15 to G15 represented in black indicate return timings in a case where the SP transition time is assumed to be 15 minutes.

A3 to E3 and A15 indicate return points in time of a job executed after the mode returns from the sleep mode. F3, G3, and B15 to G15 indicate return points in time of a job executed after the mode returns from the low power mode.

Here, as an example, it is assumed that the mode of the image forming apparatus 10 transitions to the low power mode after the job is ended.

Return 1 in FIG. 5 is a return from the sleep mode, and a job corresponding to return 1 is a job executed after the mode returns from the sleep mode. Both A3 and A15 indicate return points in time of a job executed after the mode returns from the sleep mode.

Return 2 in FIG. 5 is a return having occurred after end 1. In a case where the SP transition time is 3 minutes, the mode of the image forming apparatus 10 transitions to the sleep mode 3 minutes after a point in time of end 1. Return 2 in this case is a return having occurred in a case where the mode of the image forming apparatus 10 is the sleep mode. That is, return 2 in a case where the SP transition time is 3 minutes is a return from the sleep mode. B3 indicates a return point in time of a job corresponding to return 2.

In a case where the SP transition time is 15 minutes, the mode of the image forming apparatus 10 transitions to the sleep mode 15 minutes after the point in time of end 1. Return 2 is a return having occurred within 15 minutes from the point in time of end 1. Accordingly, return 2 in this case is a return having occurred in a case where the mode of the image forming apparatus 10 is the low power mode. That is, return 2 in a case where the SP transition time is 15 minutes is a return from the low power mode. B15 indicates a return point in time of a job corresponding to return 2.

Similar to B3, C3 to G3 also indicate return points in time of a job executed after the mode returns from the sleep mode. Similar to B15, C15 to G15 indicate return points in time of a job executed after the mode returns from the low power mode.

Here, it is assumed that the UI return time from the sleep mode is 3.0 seconds, the return time from the low power mode is 0.7 seconds, and the UI return time from the standby mode is 0.0 seconds.

The processor 20 hypothetically changes the SP transition time, calculates an average value of the UI return times, and calculates an average value of the UI return times for each SP transition time. A relationship between the SP transition time and the average value of the UI return times is an example of the first relationship. For example, the average value of the UI return times is calculated according to the following Equation.

{Number of times of returned modes (that is, number of jobs)×UI return time}/Number of jobs=average value of UI return times.

Hereinafter, a specific example will be described. It is assumed that the SP transition time is 3 minutes. It is assumed that the mode of the image forming apparatus 10 transitions to the low power mode after the job is ended. Focusing on A3 to G3 in FIG. 5, the number of times of returning from the sleep mode (that is, the number of times the job is executed after the mode returns from the sleep mode) is 5 times (A3 to E3), and the number of times of returning from the low power mode (that is, the number of times the job is executed after the mode returns from the low power mode) is two times. The total number of times of returning is 7. In this case, as represented in the following equation, the processor 20 calculates the average value (that is, an average standby time) of the UI return times in a case where the SP transition time is 3 minutes.

{5 (times)×3.0 (seconds)+2 (times)×0.7 (seconds)}/7 (times)=2.3 (seconds)

The front part corresponds to the return from the sleep mode, and the rear part corresponds to the return from the low power mode.

From the above, in a case where the SP transition time is set to 3 minutes, the average value of the UI return times is 2.3 (seconds). That is, an average of 2.3 (seconds) is required for the UI 14 to return from the power saving mode.

It is assumed that the SP transition time is 15 minutes. It is assumed that the mode of the image forming apparatus 10 transitions to the low power mode after the job is ended. Focusing on A15 to G15 in FIG. 5, the number of times of returning from the sleep mode is one, and the number of times of returning from the low power mode is 6. The total number of times of returning is 7. In this case, as represented in the following equation, the processor 20 calculates the average value of the return times in a case where the SP transition time is 15 minutes.

{1 (times)×3.0 (seconds)+6 (times)×0.7 (seconds)}/7 (times)=1.0 (seconds)

The front part corresponds to the return from the sleep mode, and the rear part corresponds to the return from the low power mode.

From the above, in a case where the SP transition time is set to 15 minutes, the average value of the UI return times is 1.0 (seconds). That is, an average of 1.0 (seconds) is required for the UI 14 to return from the power saving mode.

As described above, the processor 20 changes the SP transition time and calculates the average value of the UI return times for each SP transition time. For example, the processor 20 changes the SP transition time between 1 minute and 60 minutes, and calculates the average value of the UI return times every 1 minute. As a result, the first relationship between the SP transition time and the average value of the UI return times between 1 minute and 60 minutes is calculated. A range from 1 minute to 60 minutes is merely an example, and an upper limit value and a lower limit value in this range may be changed by the user.

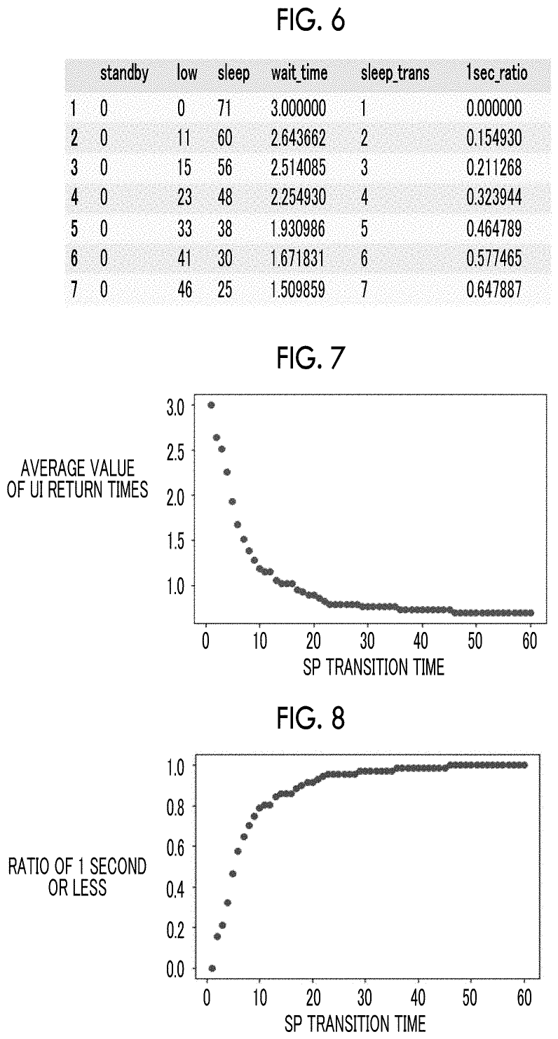

FIG. 6 shows the calculation result of the average value of the UI return times. This calculation result is the result calculated from the job history on today.

A value of “standby” indicates the number of times of returning from the standby mode. A value of “low” indicates the number of times of returning from the low power mode. A value of “sleep” indicates the number of times of returning from the sleep mode. A value (seconds) of “wait time” indicates the calculated average value of the UI return times. A value (minutes) of “sleep_trans” indicates the SP transition time. A value of “1sec_tatio” indicates a ratio of 1 second or less. The ratio of 1 second or less is a ratio at which the UI return time is 1 second or less, and is a value obtained by converting the average value of the UI return times into a ratio. That is, the ratio of 1 second or less is a ratio of the number of times the UI 14 returns in 1 second or less among the number of times of returning of all jobs. All the jobs mentioned herein are all jobs executed within a period to be calculated. In a case where the period is “today”, all the jobs on today are all jobs included in job history on history. The same applies to periods other than today (for example, day).

A graph shown in FIG. 7 shows a relationship between the SP transition time and the average value of the UI return times. A graph shown in FIG. 8 shows a relationship between the SP transition time and the ratio of 1 second or less. In FIGS. 7 and 8, a horizontal axis indicates the SP transition time. A vertical axis in FIG. 7 indicates the average value of the UI return times. A vertical axis in FIG. 8 indicates the ratio of 1 second or less. The graphs shown in FIGS. 7 and 8 are graphs showing the results calculated from the job history on today.

As shown in FIG. 7, as the SP transition time becomes longer, the average value of the UI return times becomes smaller. That is, as the SP transition time becomes longer, a waiting time of the user becomes shorter. As shown in FIG. 8, as the SP transition time becomes longer, the ratio of 1 second or less becomes higher. This situation means that as the SP transition time becomes longer, the waiting time becomes shorter.

Similar to the relationship between the SP transition time and the average value of the UI return times, the relationship between the SP transition time and the ratio of 1 second or less corresponds to an example of the first relationship.

In the number of jobs included in the job history on today is equal to or less than a threshold value, the processor 20 estimates that today is a holiday. In this case, the processor 20 outputs, as the set value of the SP transition time on the next day, a predetermined set value or a set value determined by another method without executing prediction processing to be described later.

The processor 20 records the job history for each period and calculates the first relationship for each period. For example, the processor 20 records the job history on each day in units of one day, and calculates the first relationship on each day. The processor 20 compares the first relationship on today with the first relationship on each day in the past, specifies the day on which the job history for which the relationship closest to the first relationship on today is calculated is obtained, and specifies the next day of the specified day.

Here, as an example, job histories for 15 days including the job history on today and job histories for 14 days before yesterday is used. The processor 20 calculates the first relationship on each day (that is, the relationship between the SP transition time on each day and the ratio of 1 second or less) based on the job histories for 15 days.

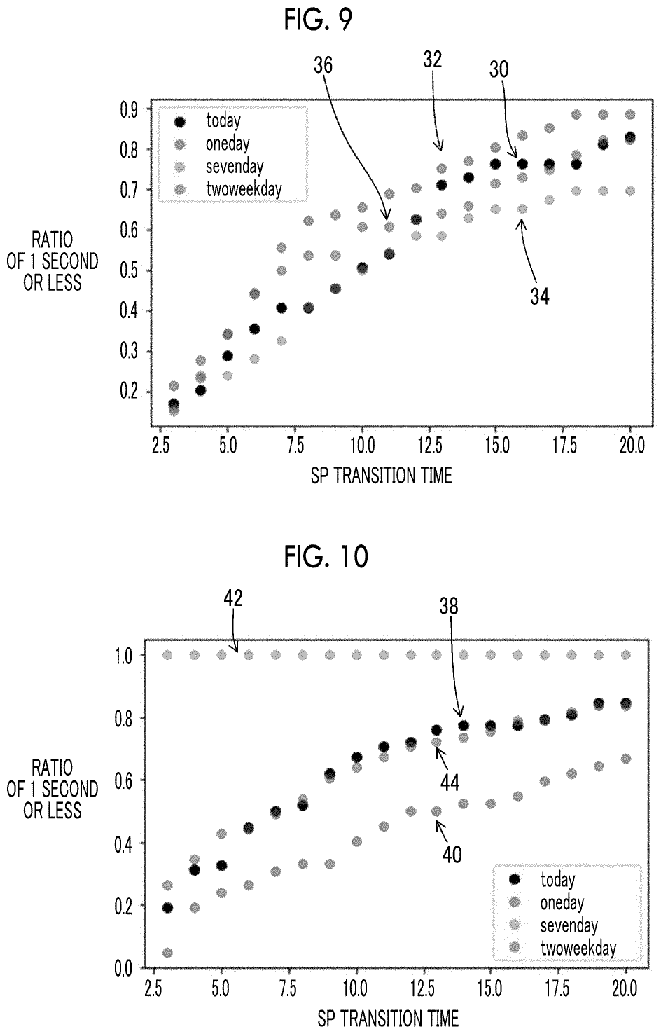

FIG. 9 shows the first relationship on each day. A horizontal axis indicates the SP transition time, and a vertical axis indicates the ratio of 1 second or less. Specifically, FIG. 9 shows first relationships on today, yesterday, one week ago, and two weeks ago, respectively. In the example shown in FIG. 9, today, yesterday, one week ago, and two weeks ago are not all holidays.

Reference numeral 30 indicates a first relationship calculated from the job history on today. Reference numeral 32 indicates a first relationship calculated from the job history on yesterday. Reference numeral 34 indicates a first relationship calculated from the job history one week ago. Reference numeral 36 indicates a first relationship calculated from the job history two weeks ago.

FIG. 10 shows the first relationship in a case where one week ago is a holiday. A horizontal axis indicates the SP transition time, and a vertical axis indicates the ratio of 1 second or less.

Reference numeral 38 indicates a first relationship calculated from the job history on today. Reference numeral 40 indicates a first relationship calculated from the job history on yesterday. Reference numeral 42 indicates a first relationship calculated from the job history one week ago. Reference numeral 44 indicates a first relationship calculated from the job history two weeks ago.

The processor 20 compares the first relationship on today with the first relationship on a day other than today except for the first relationship on the holiday, and specifies the day on which the job history for which the first relationship closest to the first relationship on today is calculated is obtained. That is, the processor 20 specifies a day on which a first relationship with a highest similarity to the first relationship on today is obtained. For example, the processor 20 determines similarity between the first relationships by using known techniques for determining similarity between the graphs. The day on which the first relationship with the highest similarity to the first relationship on today is obtained, a day on which a usage status of the image forming apparatus 10 is most similar to a usage status on today is specified.

In the example shown in FIG. 10, as indicated by reference numerals 38 and 44, the similarity between the first relationship two weeks ago and the first relationship on today is the highest. Accordingly, the processor 20 specifies two weeks ago as the day on which the job history for which the first relationship closest to the first relationship on today is calculated is obtained. Accordingly, the day on which the usage status of the image forming apparatus 10 is most similar to the usage status on today is specified as two weeks ago.

Subsequently, the processor 20 specifies the next day of the day on which the first relationship closest to the first relationship on today is obtained. In the above example, since the first relationship two weeks ago is the closest to the first relationship on today, the processor 20 specifies the next day two weeks ago (that, 13 days before today).

The processor 20 determines, as the second relationship, the first relationship calculated from the job history obtained on the next day two weeks ago (that is, 13 days before).

The processor 20 calculates the set value of the SP transition time on the next day based on the first relationship 13 days ago (that is, the second relationship) and the target value of the UI return time. The target value of the UI return time is designated by the user.

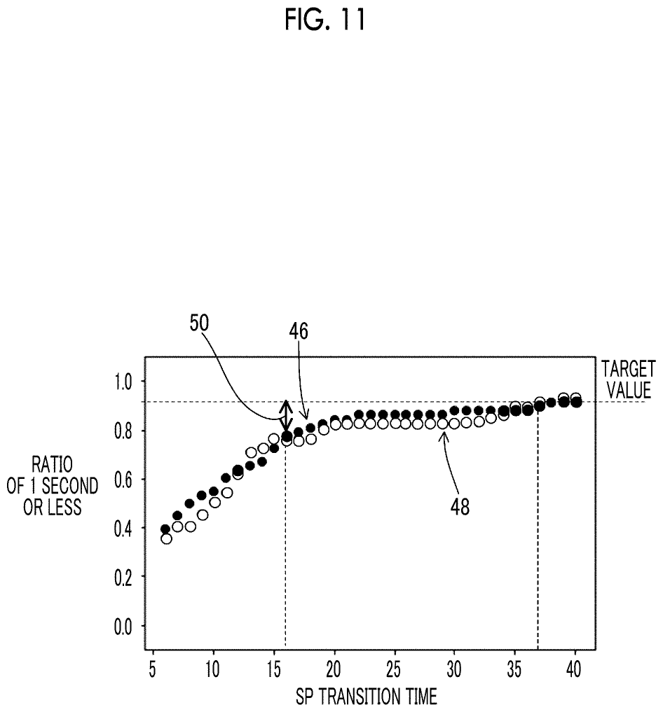

The calculation of the set value will be described with reference to FIG. 11. FIG. 11 shows the first relationship. A horizontal axis indicates the SP transition time, and a vertical axis indicates the ratio of 1 second or less.

Reference numeral 46 indicates the first relationship on today. Reference numeral 48 indicates the first relationship 13 days ago (that is, the second relationship).

For example, “0.9” is designated as the target value of the UI return time. Here, the target value is designated by a value of the ratio of 1 second or less, but the target value may be designated by the average value of the UI return times.

The processor 20 specifies the SP transition time at which the UI return time having a smallest difference from the target value of the UI return time is obtained in the first relationship 13 days ago. For example, the SP transition time is “37 minutes”. That is, 37 minutes is set as the SP transition time on the next day, and thus, it is presumed that the target value “0.9” is achieved as the ratio of 1 second or less corresponding to the UI return time. The processor 20 specifies the SP transition time at which the UI return time having the smallest difference from the target value is obtained, as the set value (hereinafter, referred to as a “set value A”) of the SP transition time on the next day.

The processor 20 may display the set value A on the display of the UI 14. The processor 20 may set the set value A in the image forming apparatus 10 and causes the mode of the image forming apparatus 10 to transition to the sleep mode according to the set value A. The processor 20 may set the set value A in the image forming apparatus 10 according to the instruction of the user, or may set the set value A in the image forming apparatus 10 without receiving the instruction of the user.

The processor 20 may change the set value A of the transition time on the next day based on a difference between an actual UI return time on today and the target value of the UI return time.

For example, the set value of the SP transition time on today is “16 minutes”. As indicated by reference numeral 50, as a result of using the set value of SP transition time on today, an actual ratio of 1 second or less (that is, a value corresponding to the average value of UI return times) is about 0.76, and there is a difference between an actual value on today and “0.9” which is the target value of the UI return time.

In this case, the processor 20 calculates a changed set value B by adding the value corresponding to the difference to the set value A or subtracting the corresponding value from the set value A. The processor 20 outputs the set value B as the set value of the transition time on the next day.

In a case where the actual value on today is less than the target value, the processor 20 adds the value corresponding to the difference to the set value A. The processor 20 may add a value obtained by multiplying the value corresponding to the difference by a predetermined coefficient to the set value A.

In a case where today's actual value is greater than the target value, the processor 20 subtracts the value corresponding to the difference from the set value B. The processor 20 may subtract the value obtained by multiplying the difference value by a predetermined coefficient from the set value A.

In a case where the difference between today's actual value and the target value of the UI return time is greater than or equal to the threshold value, the processor 20 may change the set value A based on the value corresponding to the difference to calculate the set value B. In a case where the user gives an instruction to change the set value A, the processor 20 may change the set value A and may calculate the set value B based on the value corresponding to the difference.

The processor 20 may display the set value B on the display of the UI 14. The processor 20 may set the set value B in the image forming apparatus 10 according to the instruction of the user or without receiving the instruction of the user, and may cause the mode of the image forming apparatus 10 to transition to the sleep mode according to the set value B.

The processor 20 calculates the set value A or the set value B for each day. For example, in a case where a predetermined time (for example, 20:00) elapses, the processor 20 calculates the set value A or the set value B on the next day by executing the above-mentioned processing.

Hereinafter, an energy saving effect and convenience of the user will be described. As shown in FIGS. 7 and 8, as the SP transition time becomes, the average value of the UI return times becomes shorter. In other words, as the SP transition time becomes shorter, the average value of the UI return times becomes longer. The UI return time is a time that affects the convenience of the user. As the UI return time becomes shorter, the waiting time of the user becomes shorter. Thus, the convenience of the user is improved. As the UI return time becomes longer, the waiting time of the user becomes longer. Thus, the convenience of the user deteriorates.

On the other hand, in a case where the SP transition time is short, a higher energy saving effect can be expected as compared with a case where the SP transition time is long. That is, as the SP transition time becomes shorter, the mode of the image forming apparatus 10 transitions to the sleep mode at an earlier stage. Thus, a higher energy saving effect can be expected as compared with a case where the SP transition time is long. In other words, it can be said that as the SP transition time becomes longer, the energy saving effect is reduced.

From the above, in order to improve user convenience, it is considered that the SP transition time is lengthened and the average value of the UI return times is shortened, but as the SP transition time becomes longer, the energy saving effect is reduced. On the contrary, in order to improve the energy saving effect, it is considered that the SP transition time is shortened, but as the SP transition time becomes shorter, the average value of the UI return times becomes longer. Thus, the convenience of the user deteriorates.

In the exemplary embodiment, the day on which the first relationship most similar to the first relationship on today is obtained is specified, and the first relationship (that is, the second relationship) obtained based on the job history on the “next day” of the specified day is calculated, and the set value of the SP transition time on the next day is calculated based on the second relationship and the target value of the UI return time. Since the “next day” is the day corresponding to the next day, it can be said that the usage status of the image forming apparatus 10 represented in the job history on the “next day” is similar to the usage status of the image forming apparatus 10 on the next day. Thus, the job history on “next day” is used, and thus, the set value of the SP transition time on the next day is calculated with high accuracy. The target value is a value designated by the user, and can be said to be a value that reflects the wishes of the user. The set value of the SP transition time on the next day is calculated based on the second relationship which is the first relationship on the “next day” and the target value of the UI return time, and thus, the UI return time wanted by the user is realized. Further, power control is realized in consideration of the actual usage status of the image forming apparatus 10.

The image forming apparatus 10 corresponds to an example of an information processing apparatus. Each function shown in FIG. 3 may not be executed by the image forming apparatus 10 but may be executed by an external apparatus (for example, a PC, a server, or the like) other than the image forming apparatus 10. In this case, the external apparatus corresponds to an example of the information processing apparatus. The set value of the SP transition time calculated by the external apparatus may be transmitted from the external apparatus to the image forming apparatus 10 via a communication path such as a network, or may be displayed on the display of the external apparatus. The set value calculated by the external apparatus may be input to the image forming apparatus 10 by the user.

In the above-described exemplary embodiment, although it has been described that the image forming apparatus 10 is used as an example of the processing apparatus, the exemplary embodiment may be applied to an apparatus such as a PC or a display, or may be applied to another apparatus having a sleep mode (for example, home appliances, industrial equipment, or the like).

The function of the image forming apparatus 10 is realized by the cooperation of hardware and software as an example. For example, the processor realizes the function of each apparatus by reading out and executing a program stored in the memory of each apparatus. The program is stored in the memory via a recording medium such as a CD or DVD, or via a communication path such as a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
output a set value of a transition time until an apparatus transitions to a power saving state, which is obtained based on a first history of a time interval of each processing executed by the apparatus and a target value of a return time required until the apparatus returns from the power saving state.

2. The information processing apparatus according to claim 1, wherein the processor is configured to:
calculate a first relationship between the return time and the transition time based on the first history, and
specify the set value with which the target value is achieved based on the first relationship.

3. The information processing apparatus according to claim 2, wherein the processor is configured to:
change a value of the transition time, and calculate, as the first relationship, a return time for each transition time based on a relationship between a point in time at which each processing included in the first history is executed and the transition time.

4. The information processing apparatus according to claim 2,
wherein a history of the time interval of each processing is obtained for each predetermined period, and
the processor is configured to:
specify a next period of a period in which a history for which a relationship closest to the first relationship is calculated is obtained, and
specify the set value based on a second relationship between the return time and the transition time which is calculated from a history obtained in the next period and the target value of the return time.

5. The information processing apparatus according to claim 3,
wherein a history of the time interval of each processing is obtained for each predetermined period, and
the processor is configured to:
specify a next period of a period in which a history for which a relationship closest to the first relationship is calculated is obtained, and
specify the set value based on a second relationship between the return time and the transition time which is calculated from a history obtained in the next period and the target value of the return time.

6. The information processing apparatus according to claim 4, wherein the processor is configured to:
change the specified set value based on a difference between an actual return time and the target value in a period in which the first history is obtained.

7. The information processing apparatus according to claim 5, wherein the processor is configured to:
change the specified set value based on a difference between an actual return time and the target value in a period in which the first history is obtained.

8. The information processing apparatus according to claim 1,
wherein a plurality of different power saving states are determined, and
power saving transition is carried out in a plurality of stages.

9. The information processing apparatus according to claim 2,
wherein a plurality of different power saving states are determined, and
power saving transition is carried out in a plurality of stages.

10. The information processing apparatus according to claim 3,
wherein a plurality of different power saving states are determined, and
power saving transition is carried out in a plurality of stages.

11. The information processing apparatus according to claim 4,
wherein a plurality of different power saving states are determined, and
power saving transition is carried out in a plurality of stages.

12. The information processing apparatus according to claim 5,
wherein a plurality of different power saving states are determined, and
power saving transition is carried out in a plurality of stages.

13. The information processing apparatus according to claim 6,
wherein a plurality of different power saving states are determined, and
power saving transition is carried out in a plurality of stages.

14. The information processing apparatus according to claim 7,
wherein a plurality of different power saving states are determined, and
power saving transition is carried out in a plurality of stages.

15. A non-transitory computer readable medium storing a program causing a computer to execute a process, the process comprising:
outputting a set value of a transition time until an apparatus transitions to a power saving state, which is obtained based on a first history of a time interval of each processing executed by the apparatus and a target value of a return time required until the apparatus returns from the power saving state.

16. An information processing method comprising:
outputting a set value of a transition time until an apparatus transitions to a power saving state, which is obtained based on a first history of a time interval of each processing executed by the apparatus and a target value of a return time required until the apparatus returns from the power saving state.
